(19) United States
(12) Patent Application Publication
(10) Pub. No.: US 2011/0086331 A1
(43) Pub. Date: Apr. 14, 2011

(54) SYSTEM FOR TEACHING WRITING BASED ON A USERS PAST WRITING

(75) Inventor: Yael Karov Zangvil, Tel-Aviv (IL)

(73) Assignee: GINGER SOFTWARE, INC., LEXINGTON, MA (US)

(21) Appl. No.: 12/937,618

(22) PCT Filed: Mar. 19, 2009
(86) PCT No.: PCT/IL09/00317

§ 371 Date: Dec. 29, 2010

Related U.S. Application Data
(60) Provisional application No. 61/045,438, filed on Apr. 16, 2008.

(51) Int. Cl. G09B 7/00

(52) U.S. Cl. 434/169

(57) ABSTRACT

A computer-assisted system including a memory storing samples of a user's past writing including mistakes and corrections thereof and a writing learning processor employing the samples of the user's past writing including mistakes and correactions thereof for providing lessons, exercises, games and tests to the user.

### REFERENCE TO RELATED APPLICATIONS

Reference is made to U.S. Provisional Patent Application Ser. No. 61/045,438, filed Apr. 16, 2008 and Published PCT Patent Application WO 2009016631, the disclosures of which are hereby incorporated by reference and priority of which is hereby claimed pursuant 37 CFR 1.78(a)(4) and (5)(i).

### SUMMARY OF THE INVENTION

The present invention seeks to provide a system for teaching writing based on a user's past writing. There is thus provided in accordance with a preferred embodiment of the present invention a computer-assisted system including a memory storing samples of a user's past writing including mistakes and corrections thereof and a writing learning processor employing the samples of the user's past writing including mistakes and corrections thereof for providing lessons, exercises, games and tests to the user.

Preferably, the memory also stores samples of the user's past correct usage and the writing learning processor also employs the samples of the user's past correct usage.

In accordance with a preferred embodiment of the present invention the system also includes a writing mistake processor operative to classify the user's past writing mistakes into one or more of a plurality of writing mistake types, which include one or more of the following mistake types: spelling mistakes, misused word mistakes, grammar mistakes and vocabulary mistakes. Additionally, the system also includes a writing mistake type database, which stores the plurality of writing mistake types.

Preferably, the writing learning processor employs samples of a user's past sentences for providing one or more lessons, exercises, games and tests to the user. The writing learning processor also employs one or more of the following: a dictionary, lexical database and a corpus, such as an internet corpus, and provides one or more lessons, exercises, games and tests to the user related to the user's past writing mistakes and which focus on specific mistake types characterizing the user's past writing mistakes.

Additionally, the writing learning processor employs samples of a user's past writing including mistakes and corrections thereof for adding user specific content to pre-existing templates for one or more lessons, exercises, games and tests. Preferably, the writing learning processor also adds non-user specific content from one or more of the following: a corpus, such as an internet corpus, lexical database and dictionary, which is relevant to a user's past writing including mistakes and corrections thereof, to pre-existing templates for one or more lessons, exercises, games and tests.

In accordance with a preferred embodiment of the present invention the system also includes a user writing performance report generator providing a report indicating a user's past mistakes classified by the corrections and/or by mistake type. Additionally, the writing performance report generator is also operative to provide a report indicating a user's progress over time, classified by corrections and/or by mistake type.

Preferably, the user writing performance report generator is also operative to provide a report indicating a progress over time, classified by corrections and/or by mistake type, for a selectable group of users.

### BRIEF DESCRIPTION OF THE DRAWING

The present invention will be understood and appreciated more fully from the following description, taken in conjunction with the drawings in which:

FIG. 1 is a simplified functional block diagram of a writing mistake-based teaching system, constructed and operative in accordance with a preferred embodiment of the present invention;

### DETAILED DESCRIPTION OF DETAILED EMBODIMENT

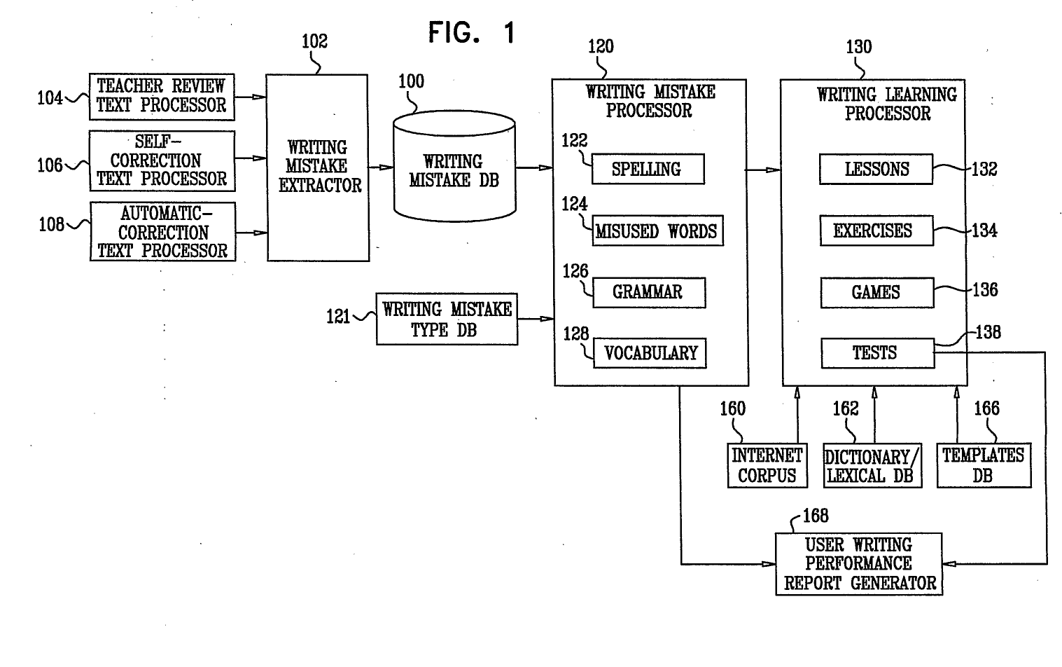

Reference is now made to FIG. 1, which is a simplified functional block diagram of a writing mistake-based teaching system, constructed and operative in accordance with a preferred embodiment of the present invention.

The system of FIG. 1 preferably includes a writing mistake/non-mistake and mistake correction database 100 which receives inputs via a mistake extractor 102 from one or more of the following writing sources:
a text processor 104 including a teacher review feature, such as MS WORD® including track changes functionality or MY ACCESS!®, commercially available from Vantage Learning of Newtown, Pa., USA, which allows a person other than the writer, such as a teacher, to correct text written by the writer;
a text processor 106 having a self-correction feature, such as a spell-checker or a grammar-checker, prompting the writer to correct his mistakes. An example of such a text processor is MS WORD®; and
a text processor 108 having an automatic correction feature, which automatically corrects writing mistakes, for example Ginger Software Correction Application, commercially available from the present assignee, Ginger Software Inc.

The inputs received by mistake extractor 102 from each of text processors 104, 106 and 108 include:
original text both mistake-free and including one or more mistakes; and
corrected text in which at least one mistake is corrected.

Optionally, mistake extractor 102 may receive information indicating the classification of the mistake, such as whether the mistake is a spelling mistake, a grammar mistake, a misused word mistake, a stylistic mistake or a vocabulary mistake. It is noted that vocabulary mistakes may not necessarily be mistakes but rather the use of a less than optimal word.

Writing mistake/non-mistake and mistake correction database 100 preferably contains at least the following:
information, accompanied by a timestamp, regarding mistakes which is organized by the type of mistake such as:
   for spelling mistakes, the misspelled word and the corrected word;
   for misused words, grammar and vocabulary mistakes, the misused word and its context as well as the corrected word; and
information, accompanied by a timestamp, regarding correct text.

A writing mistake processor 120 interacts with writing mistake/non-mistake and mistake correction database 100 and with a writing mistake type database 121.

Writing mistake processor 120 preferably comprises the following modules:
spelling module 122, a misused word module 124, a grammar module 126 and a vocabulary module 128.

Writing mistake type database 121 preferably includes the following elements:
a collection of spelling mistake types including, those relating to common phonetic spelling mistakes and common editing mistakes; and
a catalog of grammar mistake types, typically arranged in a tree; and
a collection of custom mistake types identified and selected by a teacher or other person.

The following partial example illustrates a typical writing mistake type database useful in the present invention:

I. Spelling mistake types
A. Phonetic mistake types—Where at least two different spellings, only one of which is correct, sound the same as or similar to each other
   1. Incorrect omission of double consonants.
   For example:
      incorrect: geting/correct: getting
incorrect: stoped/correct: stopped
   2. Incorrect use of one of multiple spellings of a phoneme. Some specific types of incorrect use of one of multiple spellings of a phoneme include:
      a. Incorrect substitution of x with ks or cs or vice versa.
      For example:
   incorrect: physix/correct: physics
      b. Incorrect substitution off with ph or vice versa.
      For example:
         incorrect: fysics/correct: physics
      c. Incorrect substitution off with gh or vice versa.
      For example:
         incorrect: lauf/correct: laugh
      d. Incorrect substitution of f with v or vice versa.
      For example:
         incorrect: ov/correct: of
      e. Incorrect substitution off with th or vice versa.
      For example:
         incorrect: noting/correct: nothing
      f. Incorrect substitution of v with th or vice versa.
      For example:
         incorrect: noving/correct: nothing
      g. Incorrect substitution of c with k or s or vice versa.
      For example:
         incorrect: kat/correct: cat
         incorrect: sertain/correct: certain
      h. Incorrect selection of one of many possible written expressions of the phoneme “sha”, such as ssio, sio, sia, tio, tia & cia.
      For example:
         incorrect: compashan/correct: compassion
         incorrect: technichen/correct: technician
      i. Incorrect substitution of “dg” by “g” and vice versa.
      For example:
         incorrect: juge/correct: judge
      j. Incorrect substitution of “kn” by “n” and vice versa.
      For example:
         incorrect: nown/correct: known
      k. Incorrect substitution of “s” by “z” and vice versa.
      For example:
         incorrect: phyzics/correct: physics
      l. Incorrect substitution of “b” by “p” and vice versa.
      For example:
         incorrect: bolitics/correct: politics
   3. Substitution of correct vowel or vowels with incorrect vowel or vowels. Some specific types of substitution of correct vowel or vowels with incorrect vowel or vowels include:
      a. Incorrect substitution of “ee” by, for example, “e”, “ie”, “ea” or “i” and vice versa.
      For example:
         incorrect: tre/correct: tree incorrect: sie/correct: see
      b. Incorrect substitution of “y” by another vowel, for example, “ai”, “ie”, or “i” and vice versa.
      For example:
         incorrect: trai/correct: try
         incorrect: crei/correct: cry
      c. Incorrect omission or misplacement of silent “e” at the end of a word.
      For example:
         incorrect: tabel/correct: table
         incorrect: peopl/correct: people
B. Visual mistake types—Substitution of characters by incorrect characters having similar visual appearance
   1. Incorrect substitution of “b” for “d” and vice versa.
   For example:
      incorrect: dy/correct: by
   2. Incorrect substitution of “p” for “q” and vice versa.
      For example:
         incorrect: puota/correct: quota
   3. Incorrect substitution of “m” for “n” and vice versa.
   For example:
      incorrect: om/correct: on
   4. Incorrect substitution of “v” for “w” and vice versa.
   For example:
      incorrect: vait/correct: wait
C. Non-Phonetic and Non-Visual mistake types—Addition, omission, replacement or switching of characters, when the incorrect word does not sound the same as or similar to the correct word
   1. Incorrect addition of character or characters.
   For example:
      incorrect: tmable/correct: table
   2. Incorrect omission of character or characters.
   For example:
      incorrect: tale/correct: table
   3. Incorrect replacement of character or characters.
   For example:
      incorrect: tamle/correct: table
   4. Incorrect switching of character or characters.
   For example:
      incorrect: talbe/correct: table
D. Apostrophe usage mistake types—Addition, omission, or misplacement of apostrophe
1. Incorrect addition of apostrophe.
   For example:
      incorrect: friends'/correct: friends
2. Incorrect omission of apostrophe.
For example:
   incorrect: wouldnt/correct: wouldn't
3. Misplacement of apostrophe.
For example:
   incorrect: are'nt/correct: aren't
E. Word merger/splitting mistake types
   1. Incorrect merger of two words.
   For example:
      incorrect: endup/correct: end up
      incorrect: alot/correct: a lot
   2. Incorrect splitting of words.
   For example:
      incorrect: it self/correct: itself
      incorrect: not withstanding/correct: notwithstanding
It is appreciated that a given spelling mistake may be classified into multiple spelling mistake types. For example, “fizix” written instead of “physics”, includes the following mistake types:
   IA2b replacement of ph by f
   IA3b replacement of y by i
   IA2k replacement of s by z
   IA2a replacement of cs by x

II. Misused word mistake types—Where at least two different words, both of which are correct, but only one of which is correct in a given context, sound the same as or similar to each other. Misused word mistake types may overlap with mistake types in other categories. Each correct word which is incorrectly replaced by a misused word is categorized as a separate misused word mistake type.
Some examples of misused word mistake types include:
correct: I read the summary/incorrect: I read the summary correct: the hospital staff/incorrect: the hospital stuff
correct: the ship sailed/incorrect: the sheep sailed

III. Grammar Mistake Types which Include, Inter Alia, the Following:
1. Mistakes in usage of verbs
   a. Mistakes in tense—Each tense is categorized as a separate tense mistake type.
   b. Mistakes in subject-verb agreement.
   For example:
correct: he makes/incorrect: he make
correct: she does/incorrect: she do
2. Mistakes in usage of prepositions. Each preposition is categorized as at least one separate preposition mistake type.
For example:
   incorrect: on January/correct: in January
      incorrect: interested of football/interested in football
3. Mistakes in usage of articles. Each article is categorized as at least one separate article mistake type.
For example:
incorrect: a apple/correct: an apple
4. Mistakes in usage of single/plural forms—Usage of singular form when plural form is required and vice versa.
5. Mistakes in usage of plural forms—Each mistaken plural form is categorized as a separate plural form mistake type. Examples of separate plural form mistake types include:
incorrect: leafs/correct: leaves
   incorrect: mans/correct: men
6. Mistakes in usage of prefixes and suffixes—Each mistaken prefix and suffix is categorized as a separate prefix/suffix mistake type. Examples of separate prefix/suffix mistake types include
   incorrect: more long/correct: longer

IV. Vocabulary mistake types where only one of at least two different words having similar meanings is most suitable in a given context. Each correct word which is incorrectly replaced by a different word is categorized as a separate vocabulary mistake type.
Some examples of vocabulary mistake types include:
   incorrect: yearly subscription/correct: annual subscription
incorrect: done good/correct: done well

The various functional modules of writing mistake processor 120 provide, inter alia, the following functionalities:

Spelling module 122 processes spelling mistakes by:
cataloging each spelling mistake and mapping it to the appropriate type or types of spelling mistake;
cataloging each relevant spelling non-mistake and mapping it to a corresponding type or types of spelling mistake that could have been but was not made;
for each spelling mistake type, indicating the number of mistake occurrences of that spelling mistake type and the number of non-mistake occurrences of that spelling mistake type; and
criticality ranking of spelling mistake types according to the extent that mistakes and non-mistakes occur,
Misused words module 124 processes misused word mistakes by:
   grouping the misused words according to corresponding correctly used words;
   cataloging each relevant misused word non-mistake and mapping it to the corresponding type of misused word mistake that could have been made but was not made;
   for each correctly used word, indicating the number of mistake occurrences corresponding to that correctly used word and the number of non-mistake occurrences of that correctly used word; and
   criticality ranking of correctly used words according to the extent that mistakes and non-mistakes occur, and optionally:
   for each correctly used word, identifying sub-groups of contextual features associated with corresponding sub-groups of the misused word mistakes;
   for each sub-group of contextual features associated with a correctly used word, indicating the number of misused word mistake occurrences and the number of misused word non-mistake occurrences; and
   criticality ranking of correctly used words according to the extent that mistakes and non-mistakes occur for each sub-group of contextual features.
Grammar module 126 processes grammar mistakes by:
   cataloging each grammar mistake and mapping it to an appropriate grammar mistake type;
   cataloging each relevant grammar non-mistake and mapping it to appropriate type or types of grammar mistakes that could have been but were not made;
   for each grammar mistake type, indicating the number of mistake occurrences of that grammar mistake type and the number of non-mistake occurrences of that grammar mistake type; and
   criticality ranking of grammar mistake types according to the extent that mistakes and non-mistakes occur, and optionally:
   for each grammar mistake type, identifying sub-groups of contextual features associated with corresponding sub-groups of the grammar mistakes and non-mistakes;
   for each sub-group of contextual features associated with a grammar mistake type, indicating the number of mistake occurrences and the number of non-mistake occurrences; and
   criticality ranking of grammar mistake types according to the extent that mistakes and non-mistakes occur for each sub-group of contextual features.
Vocabulary module 128 processes vocabulary mistakes by:
   grouping the vocabulary mistakes according to their corresponding correct words;
   cataloging each relevant vocabulary non-mistake and mapping it to the appropriate type of vocabulary mistake that could have been but was not made;
   for each correctly used word, indicating the number of mistake occurrences of that correctly used word and the number of non-mistake occurrences of that correctly used word; and
   criticality ranking of correctly used words according to the extent that mistakes and non-mistakes occur, and optionally
   for each correctly used word, identifying sub-groups of contextual features associated with corresponding sub-groups of the vocabulary mistakes;
   for each sub-group of contextual features associated with a correctly used word, indicating the number of vocabulary mistake occurrences and the number of non-mistake occurrences; and
   criticality ranking of correctly used words according to the extent that mistakes and non-mistakes occur for each sub-group of contextual features.

Preferably, context and contextual features referred to hereinabove are provided in the form of CFS data as described in assignee's Published PCT application WO 2009016631, which is hereby incorporated by reference.

It is appreciated that the writing mistake processor 120 may carry out all of the foregoing functions separately for each individual user. Alternatively, writing mistake processor 120 may provide some or all of the foregoing functions for groups of users which may be a class in a teaching environment or alternatively a virtual class of users who share one or more common mistake characteristics. Such virtual class of users may coincide with one or more class of users, differentiated from other classes by native language, country or region of origin, age or learning disabilities.

In accordance with a preferred embodiment of the present invention, a writing learning processor 130 receives outputs from the writing mistake processor 120 and provides personalized or group-customized lessons focused on the writing mistakes identified and ranked by the writing mistake processor 120. Writing learning processor 130 preferably includes the following modules: a lesson module 132, an exercise module 134, a game module 136 and a test module 138.

Preferably, the writing learning processor 130 provides all or some of the following functionalities:
identifying for the user principal types of writing mistakes of the user based inter alia on the frequency of their occurrence and other outputs of the writing mistake processor 120 and where appropriate identifying the contexts in which these mistakes most often appear;
presenting to the user rules which relate to the above writing mistakes;
providing to the user exercises, games and tests which focus on the above writing mistakes and may be further focused on the contexts in which these mistakes most often appear. These exercises preferably include texts which include past mistakes of the user as well as additional texts drawn from outside sources, such as an internet corpus; and
receiving and processing the user's exercise, game and test inputs and providing feedback to the user responsive thereto.

The writing learning processor 130 preferably works together with one or more and preferably all of an internet corpus 160, a dictionary/lexical database 162 and a template database 166.

In accordance with a preferred embodiment of the present invention a user writing performance report generator 168, which receives inputs from writing mistake processor 120 and from writing learning processor 130, provides exercise, game and test results and progress-over-time reports to a user, a teacher or an institution. Such reports may be organized by one or more of writing mistakes, writing mistake types, contextual features, users and groups of users.

The following examples of system operation are provided to illustrate the operation of a preferred embodiment of the present invention:

### Example I

### Spelling Mistakes

The following sample mistakes and corrections may be received from any one or more of teacher review text processor 104, self correction text processor 106 and automatic correction text processor 108 (FIG. 1). The relevant spelling mistakes are indicated in bold and the corrections are indicated in brackets [ ].
“Mumy said it is time you left the hose but stay togever” [together]
“They billt a howse out ove staws” [of].
“He tock a dep bref” [breath]
“The wolf wasnt cald big and bad for nufinck” [nothing]

The writing mistake extractor 102 (FIG. 1) extracts the mistakes and corrections and enters them in the writing mistake database 100 (FIG. 1), for example, as follows:
togever→together, ove→of, bref→breath, nufinck→nothing

The spelling module 122 in the writing mistake processor 120 maps each spelling mistake to one or more writing mistake types which appear in the writing mistake type database 121.

This mapping can be visualized with reference to the writing mistake types given in the above example, illustrating writing mistake type database 121 as follows:
The four extracted mistakes and corrections:
   togever→together, ove→of, bref breath, nufinck→nothing

are each mapped to the following mistake types given in the above example:
I. Spelling mistake types
   A. Phonetic mistake types
      2. Incorrect use of one of multiple spellings of a phoneme
         d. incorrect substitution off with v or vice versa;
         e. incorrect substitution of f with th or vice versa; and
         f. incorrect substitution of v with th or vice versa; and

| | | Writing Mistake |
|---|---|---|
| Mistake | Correction | Type |
| Ove | Of | IA2d |
| Togaver | Together | IA2f |
| Bref | Breath | IA2e |
| Nufing | Nothing | IA2e |

It is appreciated that only a partial mapping is illustrated herein and that additional mapping to additional mistake types is normally provided.

The system and more particularly, the spelling module 122 of the writing mistake processor 120, recognizes a repeated tendency of the user to incorrectly substitute consonants which are phonetically similar, in particular the ‘v’ and ‘th’ phonetic family.

In accordance with a preferred embodiment of the present invention, the writing learning processor 130 provides a lesson, exercise or game designed to assist the user to avoid this type of mistake, e.g. how to differentiate between correct usages of v, f and th.

The operation of the writing learning processor 130 is summarized below:

The writing learning processor 130 receives the following inputs:
a. The user's own mistakes and corrections thereof, which are received from the writing mistake processor 120:

| Mistake | Correction |
|---|---|
| Ove | Of |
| Togaver | Together |
| Bref | Breath |
| Nufing | Nothing |

b. The user's own sentences and fully corrected sentences, both of which are also received from the writing mistake processor 120:
User's own sentences:
   “Mumy said it is time you left the hose but stay togever”
   “They billt a howse out ove staws”
   “He tock a dep bref”
   “The wolf wasnt cald big and bad for nufinck”
User's own sentences fully corrected:
   “Mummy said it is time you left the house but stay together”
   “They built a house out of straws”
   “He took a deep breath”
   “The wolf wasn't called big and bad for nothing”
c. Many additional sentences drawn from an internet corpus or other suitable corpus 160 which include words which were mistakenly spelled by the user in the above sentences, for example:
   “They are walking to school together”
   “The family that prays together stays together”
The additional sentences are selected to be relatively simple and to appear in the corpus with high frequency.
d. Many additional words, taken from a dictionary or lexical database 162, which include letter combinations which were the subject of the above user mistakes.

| ‘th’ | ‘v’ | ‘f’ |
|---|---|---|
| Feather | Favor | Aloof |
| Broth | Glove | Gift |
| Ether | Stove | Effort |
| . . . | . . . | . . . |

The additional words are selected to be relatively simple and to appear in the corpus with high frequency.
e. Many additional sentences drawn from an internet corpus or other suitable corpus 160 which include the additional words appearing in section d. above,
for example:
   “Mom prepared a chicken broth”
   “I received a gift”

The above inputs, exemplified in a.-e. above are employed by the writing learning processor 130 for producing at least one or more of a lesson, exercise, game and test.

The following is a partial example of a typical lesson produced by lesson module 132:

SPELLING LESSON V/F/TH:
YOUR ERRORS AND CORRECTIONS:

| Mistake | Correction |
|---|---|
| Ove | Of |
| Togaver | Together |
| Bref | Breath |
| Nufing | Nothing |

COMMON WORDS WITH TH, V AND F, CORRECTLY SPELLED:

| ‘th’ | ‘v’ | ‘f’ |
|---|---|---|
| Feather | Favor | Aloof |
| Broth | Glove | Gift |
| Ether | Stove | Effort |
| together | . . . | Of |
| Breath | . . . | . . . |
| Nothing | . . . | . . . |

The following is a partial example of a typical exercise:
a. Exercise module 134 provides an audio input to the user initially including words identified to the user as containing the letter “f”, followed by words identified to the user as containing the letter “v”, followed by words identified to the user as containing the letters “th”. The user is asked to write those words and receives feedback from the exercise module 134 with any corrections.
b. Thereafter exercise module 134 provides an audio input to the user including a mixture of words as containing the letters “f”, “v” and “th” without providing to the user a prior indication of the letter or letters contained in each such word. The user is asked to write those words and receives feedback from the exercise module 134 with any corrections.
c. Thereafter exercise module 134 provides an audio input to the user including the following sentences including words containing the letters “f”, “v” and “th” without providing to the user a prior indication of the letter or letters contained in each such word. The user is asked to write those sentences and receives feedback from the exercise module:
User's own sentences fully corrected,
for example:
   “They built a house out of straws”
   “Mummy said it is time you left the house but stay together”
“He took a deep breath”
   “The wolf wasn't called big and bad for nothing”
Many additional sentences drawn from an internet corpus or other suitable corpus 160 which include words which were mistakenly spelled by the user in the above sentences,
for example:
   “They are walking to school together”
   “The family that prays together stays together”
Many additional sentences drawn from an internet corpus or other suitable corpus 160 which include the additional words appearing in section d. above,
for example:
   “Mom prepared a chicken broth”
   “I received a gift”

The following is a partial example of a typical game:
a. Game module 136 provides an audio-visual input to the user showing a fanciful character initially speaking words identified to the user as containing the letter “f”, followed by words identified to the user as containing the letter “v”, followed by words identified to the user as containing the letters “th”. The user is asked by the fanciful character to write those words and receives feedback from the game module 136, preferably in the form of advancement steps in a video game, preferably indicating corrections.
b. thereafter game module 136 provides an audio-visual input to the user showing the fanciful character initially speaking words including a mixture of words as containing the letters “f”, “v” and “th” without providing to the user a prior indication of the letter or letters contained in each such word. The user is prompted by the fanciful character to write those words and receives feedback from the game module 136, preferably in the form of further advancement steps in the video game, preferably indicating any corrections.
c. thereafter game module 136 provides an audio-visual input to the user showing the fanciful character initially speaking words including the following sentences including words containing the letters “f”, “v” and “th” without providing to the user a prior indication of the letter or letters contained in each such word. The user is prompted by the fanciful character to write those words and receives feedback from the game module 136, preferably in the form of additional advancement steps in the video game, preferably indicating any corrections.
User's own sentences fully corrected,
for example:
   “They built a house out of straws”
   “Mummy said it is time you left the house but stay together”
“He took a deep breath”
“The wolf wasn't called big and bad for nothing”
Many additional sentences drawn from an internet corpus or other suitable corpus 160 which include words which were mistakenly spelled by the user in the above sentences,
for example:
   “They are walking to school together”
   “The family that prays together stays together”
Many additional sentences drawn from an internet corpus or other suitable corpus 160 which include the additional words appearing in section d. above,
for example:
   “Mom prepared a chicken broth”
“I received a gift”
At the end of the game, the user is given a score and awarded a prize commensurate with the score.

The following is a partial example of a typical test:
a. Test module 138 provides an audio input to the user including a mixture of words as containing the letters “f”, “v” and “th” without providing to the user a prior indication of the letter or letters contained in each such word. The user is asked to write those words.
b. Thereafter test module 138 provides an audio input to the user including the following sentences including words containing the letters “f”, “v” and “th” without providing to the user a prior indication of the letter or letters contained in each such word. The user is asked to write those sentences.
User's own sentences fully corrected,
for example:
   “They built a house out of straws”
   “Mummy said it is time you left the house but stay together”
   “He took a deep breath”
   “The wolf wasn't called big and bad for nothing”
Many additional sentences drawn from an internet corpus or other suitable corpus 160 which include words which were mistakenly spelled by the user in the above sentences,
for example:
   “They are walking to school together”
   “The family that prays together stays together”
Many additional sentences drawn from an interne corpus or other suitable corpus 160 which include the additional words appearing in section d. above,
for example:
“Mom prepared a chicken broth”
“I received a gift”
   At the end of the test, the user is given a score by the test module 138 and this score is preferably provided to the user writing performance generator 168.

It is a particular feature of the present invention that personalized data from each user's accumulated writing mistakes and writing performance is automatically integrated into pre-existing templates for lessons, exercises, games and tests. Such templates may be based on commercially available lessons, exercises, games and tests, for example from:

NetRover (http://www.netrover.com/˜kingskid/writing/Kids Writing.html),

English-online (http://www.english-online.org.uk/),

Rosetta-Stone (www.rosettastone.com),

http://www.kaptest.com/kep_domestic.jhtml,

http://www.eduplace.com/kids/hme/6_{—}8/index.html,

http://www.funbrain.com/grammar/, and

http://wwvv.scholastic.com/kids/homework/communicator.htm.

Such templates may be stored in a template database 166.

Examples of suitable templates into which personalized data from each user's accumulated writing mistakes and writing performance may be automatically integrated include:

A. Exercise templates:
1. Correct insertion of correct word in a given context based on suggested correct answers
   a. The user is presented with a sentence;
   b. One word in the sentence is blank;
   c. At least two choices of existing words which are similar in sound or spelling are presented;
   d. The user is prompted to select one word; and
   e. The user receives feedback.
2. Correct insertion of correct word in a given context based on audio input without suggested correct answers
   a. The user is presented with a written sentence, wherein a potentially problematic part of a word is emphasized,
      for example:
         She is very generous
   b. The user is presented with the same sentence orally with audio emphasis on the problematic part;
   c. The user is presented with the same sentence where the word including the potentially problematic part is missing;
   d. The user is presented with the complete same sentence orally with audio emphasis on the problematic part;
   e. The user is prompted to write the missing word; and
   f. The user receives feedback.
      B. Game templates:
1. Correct insertion of correct word in a given context
   a. A fanciful character presents the user with a sentence;
   b. One word in the sentence is blank;
   c. At least two choices of existing words which are similar in sound or spelling are presented;
   d. The user is prompted to select one word.
   e. A correct answer progresses the fanciful character towards a goal.
2. Correct insertion of correct word in a given context based on audio input without suggested correct answers
   a. A fanciful character presents the user with a written sentence, wherein a potentially problematic part of a word is emphasized,
      for example:
         She is very generOUS
   b. The fanciful character speaks the same sentence orally with audio emphasis on the problematic part;
   c. The fanciful character presents the user with the same sentence where the word including the potentially problematic part is missing;
   d. The fanciful character again speaks the complete same sentence with audio emphasis on the problematic part;
   e. The fanciful character prompts the user to write the missing word; and
   f. A correct answer progresses the fanciful character towards a goal.

### Example Ii

### Grammar Mistakes

The following sample mistakes and corrections may be received from any one or more of teacher review text processor 104, self correction text processor 106 and automatic correction text processor 108 (FIG. 1). The relevant grammar mistakes are indicated in bold and the corrections are indicated in brackets [ ].
“The family do not want the servant back even though the girl pleads” [does]
“Sound is an area in witch I have discovered I am fairly strong and it do interest me very much as well” [does]
“This do not matter because I will land on soft snow” [does]
“She go there every day” [goes]

The writing mistake extractor 102 (FIG. 1) extracts the mistakes and corrections and enters them in the writing mistake database 100 (FIG. 1), for example, as follows:
the family do→the family does, it do→it does, this do→this does, she go→she goes

A grammar module 126 in the writing mistake processor 120 maps each grammar mistake to one or more writing mistake types which appear in the writing mistake type database 121.

This mapping can be visualized with reference to the writing mistake types given in the above example illustrating writing mistake type database 121 as follows:
The four extracted mistakes and corrections:
   the family do→the family does, it do→it does, this do→this does, she go→she goes
are each mapped to the following mistake types given in the above example:
III. Grammar mistake types
   1. Mistakes in usage of verbs
      B. Mistakes in subject-verb agreement

| | | Writing Mistake |
|---|---|---|
| Mistake | Correction | Type |
| the family do | the family | III1B |
| | does | |
| it do | it does | III1B |
| this do | this does | III1B |
| she go | she goes | III1B |

It is appreciated that only a partial mapping is illustrated herein and that additional mapping to additional mistake types is normally provided.

The system and more particularly, the grammar module 126 of the writing mistake processor 120, recognizes a repeated tendency of the user to make mistakes in subject-verb agreement.

In accordance with a preferred embodiment of the present invention, the writing learning processor 130 provides a lesson, exercise or game designed to assist the user to avoid this type of mistake, for example, by making a correct choice of subject-verb agreement.

The operation of the writing learning processor 130 is summarized below.

The writing learning processor 130 receives the following inputs:
a. The user's own mistakes and corrections thereof, which are received from the writing mistake processor 120:

| Mistake | Correction |
|---|---|
| the family do | the family does |
| it do | it does |
| this do | this does |
| she go | she goes |

b. The user's own sentences and fully corrected sentences, both of which are also received from the writing mistake processor 120:
   User's own sentences:
      “The family do not want the servant back even though the girl pleads”
      “Sound is an area in witch I have discovered I am fairly strong and it do intrest me very much as well”
      “This do not matter because I will land on soft snow”
      “She go there every day”
c. The user's own sentences fully corrected:
   “The family does not want the servant back even though the girl pleads”
   “Sound is an area in which I have discovered I am fairly strong and it does interest me very much as well”
   “This does not matter because I will land on soft snow”
   “She goes there every day”
d. Many additional sentences drawn from an internet corpus or other suitable corpus 160 which include verbs in present tense,
for example:
   “What does this mean?”
   “Please do not disturb”
   “What shall I do to convince them?”
   “She does it for a purpose”
“The show must go on”
   “This goes without saying”
   “This sofa won't go with the chairs”
   “Michelle goes to school now”
   “She walks to school on her own”
   “The family prays together”

The additional sentences are selected to be relatively simple and to appear in the corpus with high frequency.

The above inputs, exemplified in a.-d. above are employed by the writing learning processor 130 for producing at least one or more of a lesson, exercise, game and test.

The following is a partial example of a typical lesson produced by the lesson module 132:

GRAMMAR LESSON—SUBJECT-VERB AGREEMENT
YOUR ERRORS AND CORRECTIONS:

| Mistake | Correction |
|---|---|
| the family do | the family does |
| it do | it does |
| this do | this does |
| she go | she goes |

HERE ARE SENTENCES WHICH ILLUSTRATE CORRECT SUBJECT-VERB AGREEMENT:
   “What does this mean?”
   “Please do not disturb”
   “What shall I do to convince them?”
   “She does it for a purpose”
“The show must go on”
   “This goes without saying”
   “This sofa won't go with the chairs”
   “Michelle goes to school now”
   “She walks to school on her own”
   “The family prays together”

The following is a partial example of a typical exercise:
a. Exercise module 134 provides the user with the written sentences from the subject-verb agreement lesson above, the relevant verb being replaced with a blank. The user is asked to fill in the blank with one selection of two options. Once the user makes a selection, the exercise module provides the user with feedback
The exercise module 134 preferably employs the user's own sentences,
for example:
   “The family ______ not want the servant back even though the girl pleads” (do, does)
   “Sound is an area in witch I have discovered I am fairly strong and it ______ interest me very much as well” (do, does)
   “This ______ not matter because I will land on soft snow” (do, does)
   “She ______ there every day” (go, goes)
Many additional sentences are drawn from an internet corpus or other suitable corpus 160, which sentences include verbs in the present tense,
for example:
   “What ______ this mean?” (do, does)
   “Please ______ not disturb” (do, does)
   “What shall I ______ to convince them?” (do, does)
   “She ______ it for a purpose” (do, does)
   “The show must ______ on” (go, goes)
   “This ______ without saying” (go, goes)
   “This sofa won't ______ with the chairs” (go, goes)
   “Michelle ______ to school now” (go, goes)
   “She ______ to school on her own” (walk, walks)
   “The family ______ together” (pray, prays)

The following is a partial example of a typical game:
a. Game module 136 provides an audio-visual input to the user showing a fanciful character initially presenting sentences including correct subject verb agreement. Thereafter the character presents sentences lacking the verb and the user is asked by the fanciful character to select the correct verb from among choice presented to the user. The user makes choices and receives feedback from the game module 136, preferably in the form of advancement steps in a video game, preferably indicating corrections.
The game module 136 preferably uses the user's own sentences,
for example:
   “The family ______ not want the servant back even though the girl pleads” (do, does)
   “Sound is an area in witch I have discovered I am fairly strong and it ______ interest me very much as well” (do, does)
   “This ______ not matter because I will land on soft snow” (do, does)
   “She ______ there every day” (go, goes)
Many additional sentences may be drawn from an internet corpus or other suitable corpus 160 which include verbs in present tense,
for example:
   “What ______ this mean?” (do, does)
   “Please ______ not disturb” (do, does)
   “What shall I ______ to convince them?” (do, does)
   “She ______ it for a purpose” (do, does)
   “The show must ______ on” (go, goes)
   “This ______ without saying” (go, goes)
   “This sofa won't ______ with the chairs” (go, goes)
   “Michelle ______ to school now” (go, goes)
   “She ______ to school on her own” (walk, walks)
   “The family ______ together” (pray, prays)
   At the end of the game, the user is given a score and awarded a prize commensurate with the score.

The following is a partial example of a typical test:
a. Test module 138 provides the user with the written sentences from the subject-verb agreement lesson above, the relevant verb being replaced with a blank. The user is asked to fill in the blank with one selection of two options.
The test module 138 preferably employs the user's own sentences,
for example:
   “The family ______ not want the servant back even though the girl pleads” (do, does)
   “Sound is an area in witch I have discovered I am fairly strong and it ______ interest me very much as well” (do, does)
   “This ______ not matter because I will land on soft snow” (do, does)
   “She ______ there every day” (go, goes)
Many additional sentences drawn from an internet corpus or other suitable corpus 160 which include verbs in the present tense,
for example:
   “What ______ this mean?” (do, does)
   “Please ______ not disturb” (do, does)
   “What shall I ______ to convince them?” (do, does)
   “She ______ it for a purpose” (do, does)
   “The show must ______ on” (go, goes)
   “This ______ without saying” (go, goes)
   “This sofa won't ______ with the chairs” (go, goes)
   “Michelle ______ to school now” (go, goes)
   “She ______ to school on her own” (walk, walks)
   “The family ______ together” (pray, prays)
At the end of the test, the user is given a score by the test module 138 and this score is preferably provided to the user writing performance generator 168.

It is a particular feature of the present invention that personalized data from each user's accumulated writing mistakes and writing performance is automatically integrated into pre-existing templates for lessons, exercises, games and tests. Such templates may be based on commercially available lessons, exercises, games and tests, for example from:

Brainpop (www.brainpop.com),

NetRover (http://www.netrover.com/˜kingskid/writing/Kids Writing.html),

English-online (http://www.english-online.org.uk/),

Rosetta-Stone (www.rosettastone.com),

http://www.kaptest.com/kep_domestic.jhtml,

http://www.eduplace.com/kids/hme/6_{—}8/index.html,

http://www.funbrain.com/grammar/, and

http://www.scholastic.com/kids/homework/communicator.htm.

Examples of suitable templates into which personalized data from each user's accumulated writing mistakes and writing performance may be automatically integrated include:

A. Exercise templates:
1. Correct insertion of a verb in a given context based on suggested correct answers
   a. The user is presented with a sentence;
   b. One word in the sentence is blank;
   c. At least two choices of verb are presented;
   d. The user is prompted to select one verb; and
   e. The user receives feedback.

B. Game templates:
1. Correct insertion of a verb in a given context
   a. A fanciful character presents the user with a sentence;
   b. One word in the sentence is blank;
   c. At least two choices of verb are presented;
   d. The user is prompted to select one word; and
   e. A correct answer progresses the fanciful character towards a goal.

It is also a particular feature of the present invention that the user writing performance generator 168 provides a report on the user's progress over time, classified by at least one of corrections and mistake type. This progress over time reporting functionality preferably employs the time stamp assigned to each user mistake in writing mistake database 100.

The user writing performance generator 168 preferably also provides the above reports for selectable groups of users, so as to provide a quantitative tool useful for evaluation of classes, teachers and schools.

It will be appreciated by persons skilled in the art that the present invention is not limited to what has been particularly shown and described hereinabove. Rather, the scope of the invention includes both combinations and sub-combinations of various features described hereinabove as well as modifications and variations thereof which would occur to a person skilled in the art upon reading the foregoing description and which are not in the prior art.

1. A system for teaching writing based on a user's past writing, the system comprising:
a memory storing at least samples of a user's past writing including mistakes and corrections thereof; and
a writing learning processor employing said at least samples of a user's past writing including mistakes and corrections thereof for providing at least one of lessons, exercises, games and tests to the user.

2. A system for teaching writing based on a user's past writing according to claim 1 and wherein said memory also stores at least samples of said user's past correct usage and said writing learning processor also employs said at least samples of said user's past correct usage.

3. A system for teaching writing based on a user's past writing according to claim 1 and also comprising a writing mistake processor operative to classify said user's past writing mistakes into at least one of a plurality of writing mistake types.

4. A system for teaching writing based on a user's past writing according to claim 3 and wherein said plurality of writing mistake types include at least one of spelling mistakes, misused word mistakes, grammar mistakes and vocabulary mistakes.

5. A system for teaching writing based on a user's past writing according to claim 3 and also comprising a writing mistake type database which stores said plurality of writing mistake types.

6-9. (canceled)

10. A system for teaching writing based on a user's past writing according to claim 1 and wherein said writing learning processor employs said at least samples of a user's past writing including mistakes and corrections thereof for adding user specific content to pre-existing templates for at least one of lessons, exercises, games and tests.

11-18. (canceled)

19. A method for teaching writing based on a user's past writing, the method comprising:
storing at least samples of a user's past writing including mistakes and corrections thereof; and
employing said at least samples of a user's past writing, including mistakes and corrections thereof, for providing at least one of lessons, exercises, games and tests to the user.

20. A method for teaching writing based on a user's past writing according to claim 19 and also comprising:
storing at least samples of said user's past correct usage; and
employing said at least samples of said user's past correct usage.

21. A method for teaching writing based on a user's past writing according to claim 19 and also comprising classifying said user's past writing mistakes into at least one of a plurality of writing mistake types.

22. A method for teaching writing based on a user's past writing according to claim 21 and wherein said plurality of writing mistake types include at least one of spelling mistakes, misused word mistakes, grammar mistakes and vocabulary mistakes.

23. A method for teaching writing based on a user's past writing according to claim 21 and also comprising storing said plurality of writing mistake types in a writing mistake type database.

24. A method for teaching writing based on a user's past writing according to claim 19 and also comprising employing at least samples of a user's past sentences for providing said at least one of lessons, exercises, games and tests to the user.

25. A method for teaching writing based on a user's past writing according to claim 19 and also comprising employing at least one of a dictionary, lexical database and a corpus for providing said at least one of lessons, exercises, games and tests to the user related to said user's past writing mistakes.

26. A method for teaching writing based on a user's past writing according to claim 19 and also comprising employing an internet corpus for providing said at least one of lessons, exercises, games and tests to the user which relate to said user's past writing mistakes.

27. (canceled)

28. A method for teaching writing based on a user's past writing according to claim 19 and also comprising employing said at least samples of a user's past writing including mistakes and corrections thereof for adding user specific content to pre-existing templates for at least one of lessons, exercises, games and tests.

29. A method for teaching writing based on a user's past writing according to claim 19 and also comprising adding non-user specific content from at least one of a corpus, lexical database and dictionary, which is relevant to a user's past writing including mistakes and corrections thereof, to pre-existing templates for at least one of lessons, exercises, games and tests.

30. A method for teaching writing based on a user's past writing according to claim 19 and also comprising adding non-user specific content from an internet corpus, which is relevant to a user's past writing including mistakes and corrections thereof, to pre-existing templates for at least one of lessons, exercises, games and tests.

31. A method for teaching writing based on a user's past writing according to claim 19 and also comprising providing a report indicating a user's past mistakes classified by said corrections.

32. A method for teaching writing based on a user's past writing according to claim 19 and also comprising providing a report indicating a user's past mistakes classified by mistake type.

33. A method for teaching writing based on a user's past writing according to claim 32 and also comprising providing a report indicating a user's progress over time, classified by corrections.

34. A method for teaching writing based on a user's past writing according to claim 32 and also comprising providing a report indicating a user's progress over time, classified by mistake type.

35-36. (canceled)
